(19) United States
(12) Patent Application Publication
(10) Pub. No.: US 2012/0144219 A1
(43) Pub. Date: Jun. 7, 2012

(54) Method of Making Power Saving Recommendations in a Server Pool

(75) Inventors: Abdolreza Salahshour, Raleigh, NC (US); Samar Choudhary, Morrisville, NC (US); Gargi B. Dasgupta, New Delhi (IN); Anindya Neogi, New Delhi (IN); Balan Subramanian, Cary, NC (US); Akshat Verma, New Delhi (IN)

(73) Assignee: INTERNATIONAL BUSINESS MACHINES CORPORATION, Armonk, NY (US)

(21) Appl. No.: 12/960,690

(22) Filed: Dec. 6, 2010

(51) Int. Cl. G06F 1/32

(52) U.S. Cl. 713/322

(57) ABSTRACT

A method, system and computer-usable medium are disclosed for optimizing the power consumption of a plurality of information processing systems. Historical usage data representing power usage of a plurality of information processing systems is retrieved in response to a request to generate power savings recommendations. Statistical analysis is performed on the historical usage data are to determine usage patterns, which are then further analyzed to determine repetitions of the usage patterns. In turn, the repetitions of the usage patterns are analyzed to generate power consumption management recommendations to initiate power consumption management actions at particular times. One or more business constraints are determined, which are used to generate constraints to the power consumption management recommendations.

### BACKGROUND OF THE INVENTION

1. Field of the Invention

The present invention relates in general to the field of computers and similar technologies, and in particular to software utilized in this field. Still more particularly, it relates to optimizing the power consumption of a plurality of information processing systems.

2. Description of the Related Art

Information technology (IT) equipment, and its supporting infrastructure, is a major consumer of power. Within five years, it is expected that data centers alone will consume 4.5% of the power produced in the United States. Furthermore, data center power can be a major business expense. Reducing power consumption in data centers is rapidly becoming a major business objective and incentives are being offered by power companies to incent data center to significantly reduce their power consumption and expenses.

Power management is critical in all data center environments. In typical data centers there are often server pools consisting of a large number of hot standby servers for use when peak loads exceed the capacity of active servers. This is commonly the case when servers are over-provisioned or just-in-case provisioned. Oftentimes, these same servers are underutilized or idle, consuming power, generating heat, and requiring cooling. Optimizing power consumption of these server pools, and determining the associated cost savings, while still being able to accomplish business objectives, is difficult and complex.

In view of the foregoing there is a need for optimizing the power consumption of individual servers in a server pool by modeling their corresponding power efficiency and CPU utilization to make power savings recommendations. However, data centers are subject to business constraints for performance (e.g., response times, availability, maximum central processing unit usage, etc.). Moreover, efforts to save power should not compromise data center performance. Accordingly, business constraints should be applied to power savings recommendations to ensure that business and computing performance goals are met and maintained.

### SUMMARY OF THE INVENTION

A method, system and computer-usable medium are disclosed for optimizing the power consumption of a plurality of information processing systems. In various embodiments, historical usage data representing the power usage of a plurality of information processing systems is retrieved in response to a request to generate power savings recommendations. Statistical analysis is performed on the historical usage data are to determine usage patterns, which are then further analyzed to determine repetitions of the usage patterns. In turn, the repetitions of the usage patterns are analyzed to generate power savings recommendations to initiate power savings actions at particular times.

In these and other embodiments, utilization data and power consumption data corresponding to a plurality of information processing systems operating at different central processing unit (CPU) frequencies is processed to generate power consumption model data. In turn, the power consumption model data is processed to select an individual information processing system comprising a target efficiency value. The power consumption level of the selected information handling system is then changed to reduce its CPU frequency. In various embodiments, the power consumption model data is processed to generate a power consumption model comprising a piecewise linear regression model, an extrapolation of a base power rating and a maximum power rating, and a plurality of power consumption model extrapolations for a plurality of CPU frequencies.

In one embodiment, historical utilization data corresponding to a plurality of power consumption levels associated with the selected information handling system is processed to determine the changed power consumption level of the selected information processing system. In another embodiment, the power consumption model data and the historical utilization data is processed to generate cost savings data. In yet another embodiment, the cost savings data and historical CPU frequency data corresponding to the plurality of power consumption levels associated with the selected information handling system is processed to generate risk data. In still another embodiment, the cost data and the risk data is processed to generate a power consumption management recommendation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 shows a simplified block diagram of a power consumption optimization module for generating power savings recommendations based on historical usage data;

FIG. 3 shows a flowchart for generating power savings recommendations based on historical usage data;

FIG. 4 shows a flowchart for coalescing power saving recommendations from multiple data centers;

FIG. 5 shows a flowchart for reallocating workloads in a server pool; and

FIG. 6 shows a simplified diagram of a power optimization model for optimizing the power consumption of a pool of servers.

### DETAILED DESCRIPTION

A method, system and computer-usable medium are disclosed for optimizing power consumption of a plurality of information processing systems. As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

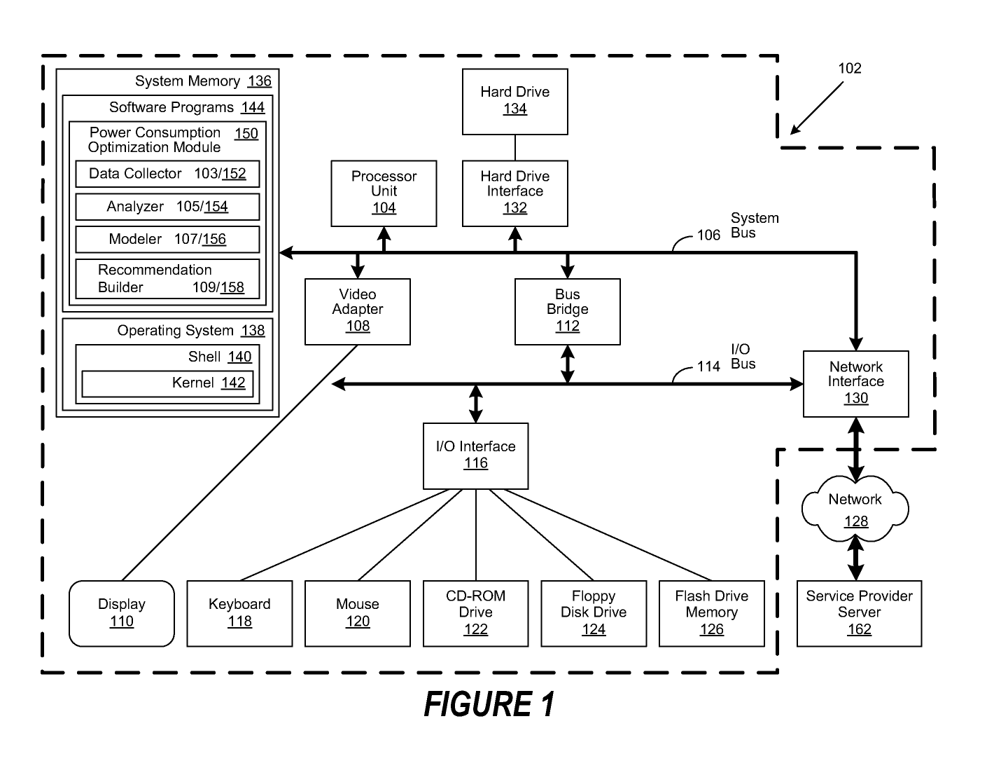

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk—Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 162 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 162.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management.

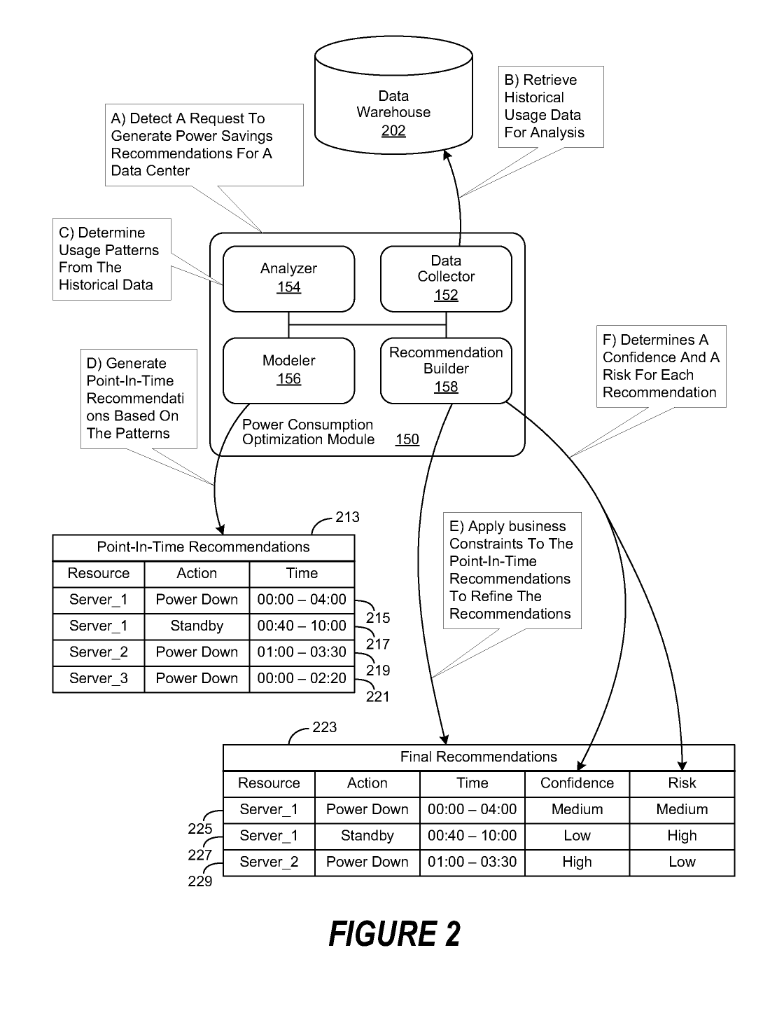

Software programs 144 may include a power consumption optimization module 150, which may further comprise a data collector 152, an analyzer 154, a modeler 156, and a recommendation builder 158. The power consumption optimization module 150 includes code for implementing the processes described in FIGS. 2-4 described hereinbelow. In one embodiment, client computer 102 is able to download the power consumption optimization module 150 from a service provider server 162.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a simplified block diagram of the operation of a power consumption optimization module as implemented in one embodiment of the invention for generating power savings recommendations based on historical usage data. In various embodiments, a power consumption optimization module 150 comprises a data collector 152, an analyzer 154, a modeler 156, and a recommendation builder 158. In this embodiment, the power consumption optimization module 150 detects a request at stage A to generate power savings recommendations for a data center. For example, the power consumption optimization module 150 detects a Hypertext transfer Protocol (HTTP) request.

At stage B, the data collector 152 retrieves historical usage data from a data warehouse 202 based on a specified date range. In various embodiments, the data range indicates the historical usage data that should be retrieved from the data warehouse 202. For example, the date range indicates that historical data from the last month should be retrieved from the data warehouse 202. As another example, the date range indicates that historical data from the last quarter should be retrieved from the data warehouse 202. In these and other embodiments, the data warehouse 202 may store central processing unit (CPU) usage, power consumption, temperature, performance data, utilization data, etc. for each resource in the data center. Examples of resources include servers, storage devices, routers, etc. In these and other embodiments, the servers may be associated with a pool of servers. The data is typically collected by agents, such as Eaton Power Xpert® agent, and IBM® Systems Director Active Power Manager® (AEM).

At stage C, the analyzer 154 determines usage patterns based on statistical analysis of the retrieved historical data. As an example, the usage patterns can be determined over a specified data range and optimization period. The analyzer 154 uses the optimization period to divide the date range into smaller time intervals. For example, if the optimization period is 24 hours, the analyzer 154 may divide the date range into 24, one-hour time intervals. As another example, if the date range is a week, the analyzer may divide the data range into seven, one-day time intervals. In various embodiments, the analyzer 154 may determine one or more patterns within each of the time intervals. The analyzer 154 can then determine repetitions of the patterns over the entire date range. For example, if the date range is a month, and the optimization period is a day, the analyzer 154 may determine a usage spike occurs every Monday from 09:00-10:00 during the month.

At stage D, the modeler 156 generates point-in-time recommendations 213 based on the repetitions of the patterns. In various embodiments, a point-in-time recommendation indicates one or more actions that can be taken to reduce power usage and cost (“power savings actions”). In these and other embodiments, the point-in-time recommendation indicates when the one or more power saving actions can be initiated, and when to terminate them if necessary. Examples of power saving actions include powering down a resource, putting a resource in standby mode, putting a resource in dynamic power savings mode, shifting workloads to more efficient servers, using Dynamic Voltage and Frequency Scaling (DVFS), deploying more efficient servers, etc. In this example, the modeler 156 generates four point-in-time recommendations 218, 217, 219, and 221. The point-in-time recommendation 215 indicates that server_1 should be powered down between 00:00 and 04:00 every day. The point-in-time recommendation 217 indicates that server_1 should be put in standby mode between 04:00 and 10:00 every day. The point-in-time recommendation 219 indicates that server_2 should be powered down between 1:00 and 03:30. The point-in-time recommendation 221 indicates that server_3 should be powered down between 00:00 and 02:20.

At stage E, the recommendation builder 158 applies business constraints to the point-in-time recommendations 213 to refine the point-in-time recommendations 213 into final recommendations 223. Business constraints indicate the specific resources available within the data center and their corresponding minimum performance criteria (e.g., response, availability, maximum CPU usage, etc.) that should be met. In this example, a business constraint may indicate that at least one server should be available at all times. If all of the point-in-time recommendations 213 are followed, the business constraint would be violated between 01:00 and 02:20 when server_1, server_2, and server_3 are all powered down due to point-in-time recommendations 215, 217, and 219 to the final recommendations 223. The recommendation builder 158 does not add point-in-time recommendation 221 because it violates the business constraint when compared in conjunction with the point-in-time recommendations 215 and 219.

At stage F, the recommendation builder 158 determines a confidence and a risk for each final recommendation. In various embodiments, the confidence may represent the quality of the historical data, quantity of the historical data (e.g., sample size), nature of the recurrence of the patterns, etc. For example, a higher confidence would be determined for a final recommendation that is based on a month's worth of data than for a final recommendation that is based on a week's worth of data. The risk can likewise represent the likelihood of a particular final recommendation violating business constraints. For example, the risk is based on an average CPU utilization for a time period in which a server is recommended to be shut down or placed in standby. To further the example, higher CPU utilization for the time period may lead to a higher risk because it is more likely that a server may be used. If the server is on standby, or shut down, business constraints for response time and availability may be violated.

In addition to confidence and risk, the recommendation builder 158 may likewise determine a cost savings for each final recommendation. In various embodiments, the cost savings may be used along with the confidence and risk to analyze the effectiveness of a particular final recommendation. For example, a final recommendation may indicate that a server should be shut down between 20:00 and 05:00 every day. In this example, the risk may be high while the cost savings may be low. Accordingly, because the final recommendation does not provide a significant cost savings and could lead to poor performance, the final recommendation may not be implemented.

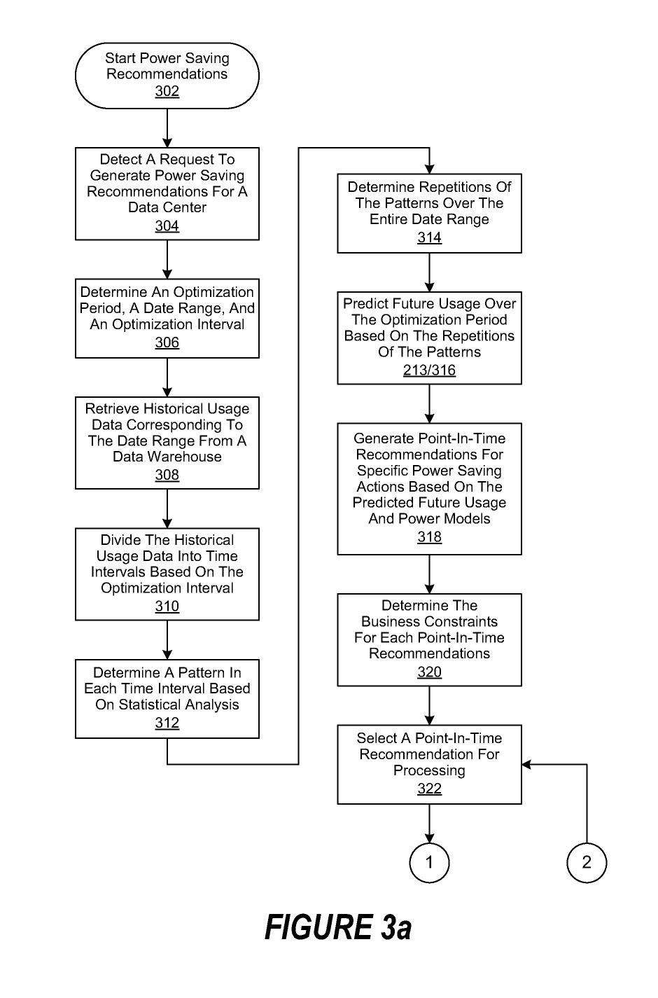

FIG. 3 shows a flowchart of the operation of a power consumption optimization module as implemented in an embodiment of the invention for generating power savings recommendations based on historical usage data. In this embodiment, power savings recommendation operations are begun in step 302, followed by the detection of a request in step 304 to generate a power savings recommendation for a data center. For example, the data center may comprise a plurality of servers configured as a pool of servers, and the completion of a wizard in a power optimization application is detected. In this example, the power optimization application is used to optimize the power consumption of the pool of servers.

In step 306, an optimization period, a date range, and an optimization period is determined from the request. In various embodiments, the optimization period represents the range of time over which power savings recommendations should be made in the future. Likewise, the date range indicates a time period for retrieving historical usage data. In these and other embodiments, the optimization period and the date range may be expressed by a quantity (e.g., a month, a number of weeks, a year, etc.) or may be represented by start and end dates. The optimization period may divide the date range into smaller time intervals for determining patterns in the date range, based on statistical analysis. For example, a user may wish to generate power saving recommendations for the next quarter based on the previous quarter's historical usage data. In this example, the optimization period is the next quarter and the date range is the previous quarter. Likewise, the optimization period may be any time interval that is smaller than the date range (e.g., a month, a day, a week, an hour, etc.).

In step 308, the historical usage data corresponding to the date range is retrieved from a data warehouse. For example, historical usage data from the past quarter is retrieved from the data warehouse. In step 310, the historical usage data is divided into time intervals based on the optimization period. For example, the optimization period may be a day (e.g., 24 hours) and the historical usage data retrieved from the data warehouse may be from the past quarter (e.g., 91 days). In this example, the historical usage data is divided into 91 time intervals, each of which represents daily usage within the date range.

In step 312, patterns are determined for each time interval based on statistical analysis. As an example, the occurrence of peaks and troughs in the historical data can be determined for each time interval. In various embodiments, averages, standard deviations, variances for usage can likewise be determined. In these and other embodiments, linear regression, polynomial approximation, etc. may likewise be used for determining patterns in the historical data. Skilled practitioners of the art will be familiar with many such statistical analysis approaches and the foregoing is not intended to limit the spirit, scope, or intent of the invention.

In step 314, repetitions of the patterns are determined over the entire date range and the resulting patterns in each time interval can be compared to the other time intervals to determine which characteristics of the patterns repeat over the date range. For example, a date range of a month may be divided into 24-hour time intervals. In this example, daily peaks and troughs may be compared to determine if the peaks and troughs occur within similar time thresholds each day. As another example, patterns may be compared for each weekday during the month to determine if a particular pattern repeats, for instance on Mondays, but not other days of the week.

In step 316, future usage over the optimization period is predicted, based on the repetitions of the patterns. For example, pattern repetitions in the date range may indicate that past usage on Sundays is low, so usage on Sundays in the optimization period is predicted to be low, as well. As another example, average usage may be highest between 08:00 and 12:00 every day in the historical data, so average usage between 08:00 and 12:00 is predicted to be high in the optimization period.

In step 318, point-in-time recommendations for specific power actions are generated, based on the predicted future usage and power models. In various embodiments, the power models relate power consumption of a resource to the resource's operations and are specific to each type of resource (e.g., individual servers in a pool of servers) in the data center. For example, a power model for an individual server in a pool of servers relates power usage to CPU utilization of the individual server, not the power usage of the entire pool of servers. Accordingly, the power model can specify power usage for idle, standby, and active CPU states for individual servers in a pool of servers. The power model may also specify recovery times and power usage for bringing an individual server up from being in shutdown, standby, or dynamic power savings modes, etc. In various embodiments, point-in-time recommendations may be based on thresholds. For example, a point-in-time recommendation may be generated to shut down a server if the predicted average CPU utilization falls below a threshold for a particular amount of time. Likewise, the thresholds may be specified by a user or determined automatically. For example, the thresholds may be determined based on recovery information in the power model.

In step 320, business constraints are determined. In various embodiments, the business constraints may be retrieved from the data warehouse. In these and other embodiments, the business constraints may have been specified in the request. In step 322, a point-in-time recommendation is selected for processing, followed by a determination being made in step 324 whether the selected point-in-time recommendation violates business constraints. In various embodiments, a point-in-time recommendation may not violate the business constraints alone. Accordingly, violation of business constraints may be determined for the point-in-time recommendation alone or in conjunction with other point-in-time recommendations.

If it is determined in step 324 that the point-in-time recommendation violates the business constraints, then a determination is made in step 326 whether the point-in-time recommendation can be revised such that it complies with the business constraints. If so, then the point-in-time recommendation is revised in step 328 to comply with the business constraints. For example, the point-in-time recommendation may indicate that a server should be shutdown during a particular time period. However, availability criteria in the business constraints may be violated if the server is shut down. Accordingly, the point-in-time recommendation may then be revised to indicate that the server should be put in standby mode rather than shut down, assuming that putting the server in standby mode does not violate the business constraints.

As another example, the point-in-time recommendation may indicate that an individual server in a pool of servers should only be in standby mode between 00:00 and 10:00. However, business constraints may specify a higher response time policy during business hours of 08:00 to 18:00 than during non-business hours. Accordingly, the point-in-time recommendation may be revised to indicate that the server should only be put in standby mode between 00:00 and 08:00.

After the point-in-time recommendation has been revised in step 328, or if it was determined in step 324 that the point-in-time recommendation does not violate business constraints, then the point-in-time recommendation is added to final recommendations in step 330. For example, the point-in-time recommendation is written to an Extensible Markup Language (XML) file.

However, if it is determined in step 326 that the point-in-time recommendation cannot be revised to comply with business constraints, then the point-in-time recommendation is not added to the final recommendations. In various embodiments, the point-in-time recommendation is not added to the final recommendations, but is stored such that it can be used in the future (e.g., if business constraints change). Additionally, updated and original point-in-time recommendations may be used as part of the final recommendations.

Thereafter, or after the point-in-time recommendations are added to the final recommendations in step 330, a determination is made in step 334 whether all point-in-time recommendations have been processed. If not, then the process is continued, proceeding with step 322. Otherwise, a confidence, a risk and a savings amount are computed in step 336 for each final recommendation. In various embodiments, the confidence may be based on the quality of the historical usage data. For example, a higher confidence would be computed for a final recommendation that is based on historical usage data that was sampled every minute, than a final recommendation that is based on historical usage data that was sampled every hour. Likewise, the risk may be based on the similarity between repetitions of the patterns over the date range. For example, a higher risk is computed for a final recommendation based on repetitions with a higher standard deviation (i.e., more jitter) than for a final recommendation based on repetitions with a lower standard deviation. The savings amount may likewise be computed based on the power model and power rate information obtained from power companies. Likewise, the optimization period can be used to select appropriate power rate information to compute the savings amount. The savings amount can then be computed based on the difference between the predicted power usage and the actual power usage when following a final recommendation. For example, a point-in-time recommendation may indicate that a server should be put on standby between 23:00 and 05:00 because the server is predicted to be idle. Accordingly, the savings amount would be computed based on the difference between the power usage if the server is idle and the power usage if the server is in standby mode between 23:00 and 05:00.

In step 338, the final recommendations are presented. For example, the final recommendations may be presented in a graphical user interface (GUI). The GUI may utilize graphs and charts to display cost savings, comparisons between historical and predicted usage, comparisons between predicted usage with and without following the final recommendations, etc.

In addition, the final recommendations may be stored in a standardized format that will allow the final recommendations to be deployed in the data center. For example, the final recommendations may be saved in an XML file. The final recommendations may likewise be saved in the data warehouse so final recommendations can be accessed by a network management system that will deploy the final recommendations in the data center. Likewise, the final recommendations may be deployed automatically based on thresholds. For example, final recommendations that have a confidence, a risk, and a savings amount above certain thresholds, may be automatically deployed. The thresholds may be specified by a user or be default values. The final recommendations may also be deployed based on selection by a user.

Although examples refer to retrieving historical usage data and determining patterns in the historical usage data in response to a request to generate power saving recommendations, embodiments are not limited to the foregoing. In various embodiments, patterns may be periodically determined as new historical usage data is stored in a data warehouse. For example, patterns may be determined in the weekly historical data at the end of the week. Power savings recommendation operations are then ended in step 340.

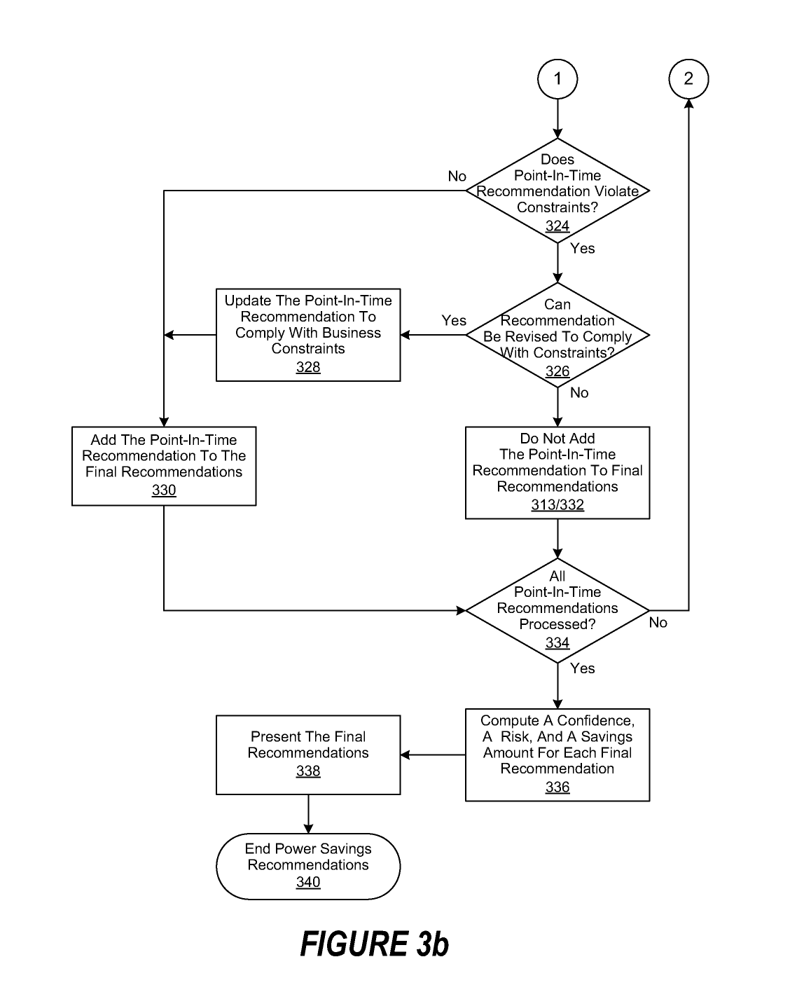

FIG. 4 shows a flowchart of example operations as implemented in an embodiment of the invention for coalescing power saving recommendations from multiple data centers. As an example, a company with multiple geographic locations may utilize multiple data centers, each of which has a corresponding set of power savings recommendations. However, the data centers may not operate entirely independently and the company may wish to implement power savings recommendations that take into account interdependencies between the multiple data centers. In this embodiment, power saving recommendation coalescing operations are begun in step 402, followed by the detection of a request in step 404 to coalesce power saving recommendations from multiple data centers. For example, an option to coalesce power saving recommendations is selected from a power optimization application.

In step 406, point-in-time power recommendations are retrieved from each data center. For example, the point-in-time power recommendations may be retrieved from local data warehouses in each data center. In step 408, relationships between the multiple data centers, and individual resources in the multiple data centers, are determined. In various embodiments, relationships may comprise data dependencies, spatial relationships, compositional relationships, distribution of business services, etc. For example, servers that provide a company's intranet may be dispersed over different data centers, but the servers are related because they provide the same business service.

In step 410, business constraints governing the overall performance of the multiple data centers are determined. For example, business constraints may be retrieved from one or more data warehouses. In step 412, the point-in-time power recommendations are processed to generate final recommendations, based on the business constraints and the relationships. For example, servers that provide a company's Voice over Internet Protocol (VoIP) may be distributed among the company's multiple data centers. Point-in-time power recommendations for each data center may recommend putting each data center's VoIP server in standby outside of business hours. However, business constraints may indicate that at least one VoIP server should be available at all times. Accordingly, because VoIP calls can be routed from any company location to any VoIP server, one VoIP server may be chosen to stay active and the point-in-time recommendation for that server is not included in the final recommendation. Confidences, risks, and savings amounts can likewise be computed for each final recommendation and techniques for generating power saving recommendations can be extended for reallocating workloads, reducing server pool size, etc. Power saving recommendation coalescing operations are then ended in step 414.

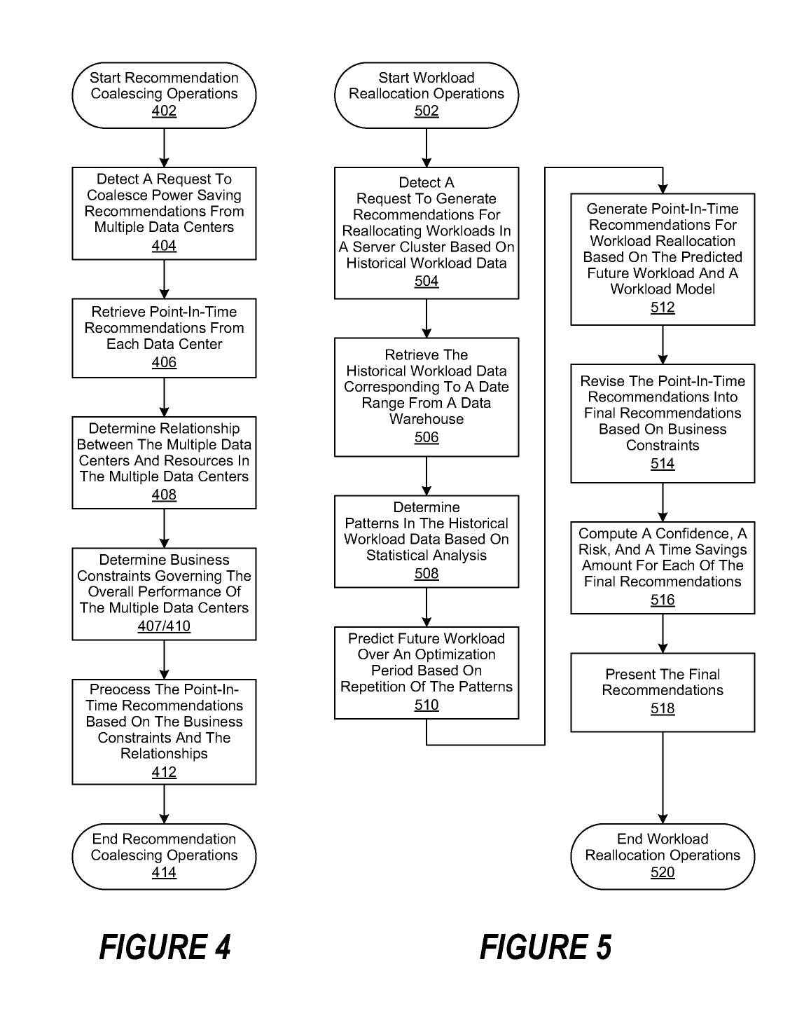

FIG. 5 shows a flowchart of example operations as implemented in an embodiment of the invention for reallocating workloads in a server pool. In this embodiment, reallocation workload operations are begun in step 502, followed by the detection of a request in step 504 to generate recommendations for the reallocation of workloads in a server pool, based on historical workload data. In step 506, historical workload data corresponding to a date range is retrieved from a data warehouse. In various embodiments, the date range may be determined based on the request. In these and other embodiments, historical workload data may comprise CPU utilization, network utilization, disk utilization, task information (e.g., task type, urgency, etc.), etc.

In step 508, patterns in the historical workload data are determined, based on statistical analysis. In various embodiments, the patterns may be determined based on optimization periods within the date range. Likewise, statistical analysis may be performed on historical workload data from each optimization period to determine occurrence of peaks and troughs, averages, standard deviations, variances, and variances to the workload. In step 510, future workload is predicted over an optimization period, based on repetition of patterns. For example, the future workload may be predicted to peak at between 09:00 and 11:00 every day because patterns in the optimization periods indicated a daily peak between 09:00 and 11:00 over the date range.

In step 512, point-in-time power recommendations for workload reallocation are generated based on the predicted future workload and a workload model. In various embodiments, the point-in-time power recommendations may indicate actions for reallocation of workload at a particular time. Examples of actions for reallocation of workload may include deploying servers with faster CPUs, assigning larger tasks to servers with more efficient processors, assigning smaller tasks to servers with less efficient processors, postponing non-critical tasks, reallocation of a percentage of the workload from one server to another, etc. In various embodiments, the workload model may comprise performance information (CPU frequency, instructions per second, latency, etc.) of each data center resource. In these and other embodiments, the workload model may be used to determine expected time to complete tasks so that appropriate actions for reallocation can be determined. For example, a server is predicted to have CPU utilization at or above 90% between 02:00 and 04:00 every Friday. A point-in-time power recommendation may be generated that indicates 20% of the server's workload should be reallocated to a second server between 02:00 and 04:00 on Fridays, because reallocating the workload will result in better efficiency for completing tasks that constitute the workload.

In step 514, the point-in-time power recommendations are refined into final recommendations based on business constraints. For example, a point-in-time power recommendation may indicate that 20% of a first server's workload should be reallocated to a second server between 02:00 and 04:00 on Fridays due to a workload peak associated with payroll processing. To further the example, a business constraint may indicate that payroll processing should only be handled by the first server for security reasons. Accordingly, the point-in-time power recommendation may be revised to indicate that tasks other than the payroll process should be reallocated to the second server between 02:00 and 04:00 on Fridays.

In step 516, a confidence, a risk, and a time savings amount is computed for each of the final recommendations. In various embodiments, the confidence may be based on the quality of the historical usage data, quantity of the historical data, nature of the recurrence of the patterns, etc. Likewise, the risk represents the likelihood of each final recommendation violating business constraints and may be based on the similarity between repetitions of the patterns over the date range. The time savings amount is likewise computed, based on the workload model and the difference between a predicted task completion time and a completion time, which is determined by following a final recommendation.

In step 518, the final recommendations are presented. For example, the final recommendations may be presented in a GUI. The GUI may utilize graphs and charts to display time savings, comparisons between historical and predicted workload, comparisons between predicted workload with and without following the final recommendations, etc. As another example, the final recommendations may be saved, so that they can be reviewed at a later time. Workload reallocation operations are then ended in step 520.

It should be understood that the depicted flowcharts are examples meant to aid in understanding embodiments and should not be used to limit embodiments or limit the scope of the claims. Embodiments may perform additional operations, fewer operations, operations in a different order, operations in parallel, and some operations differently. As an example, referring to FIGS. 3 and 4, the operation for computing a confidence, a risk and a savings amount may be performed before the operation determining whether the point-in-time power recommendations violate business constraints. As another example, referring to FIG. 5, the operation for retrieving the point-in-time power recommendations and the operations for determining relationships may be interchanged.

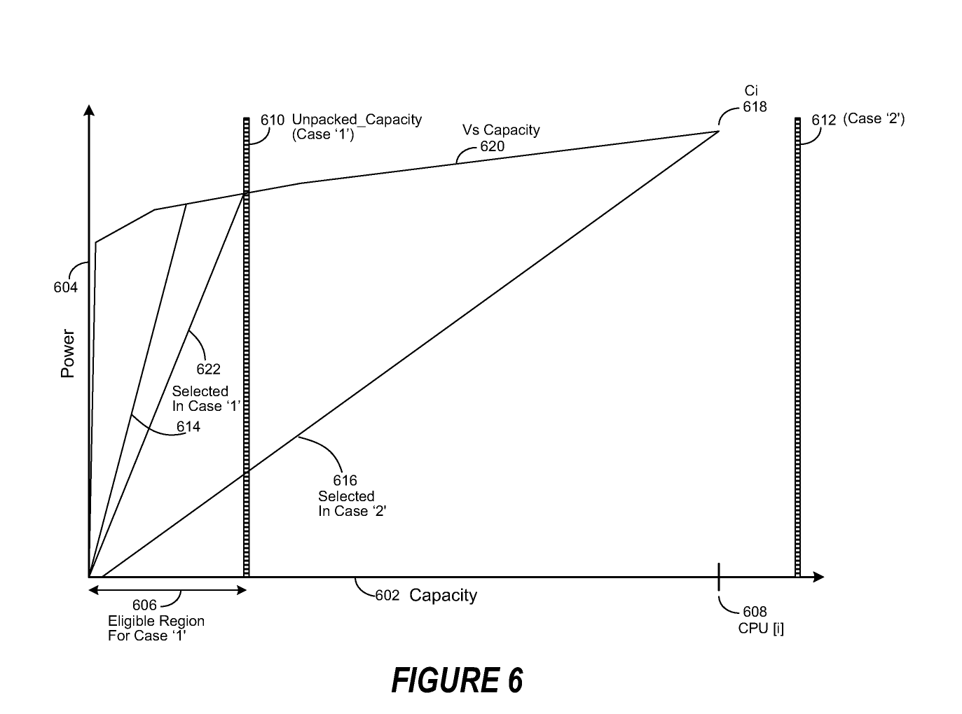

FIG. 6 shows a simplified diagram of a power optimization model as implemented in an embodiment of the invention for optimizing the power consumption of a pool of servers. In various embodiments, input data is collected corresponding to a target server pool's configuration, such as which servers are in the pool and what types of servers constitute the pool. Likewise, additional input data is collected, including each server's usage data (e.g., CPU and memory utilization of the servers, etc.), the time interval frequency (e.g., hourly, daily, weekly, etc.) that the data was collected, power data (e.g., power measurements of the servers), and any other applicable constraints.

The power model depicted in FIG. 6 is then built for each server type in the pool from the collected utilization and power usage data. The depicted model captures the behavior of the server type in terms of power consumption at various levels of utilization. In one embodiment the power model is built by co-relating the utilization and power data to build a piece-wise linear regression model when sufficient power data is available. In another embodiment, the power model is built by using the base power and maximum power ratings of the server type and extrapolating for intermediate values, assuming a piece-wise linear model when sufficient power data is unavailable.

Once the power model is built it is used for recommendation generation. As an example, the power model may be represented as a power-used vs. CPU utilization curve. In one embodiment, the power model for different time interval frequencies (‘f’/3, ‘f’/6, etc.) can be extrapolated using a multiplicative factor, from the power model build for frequency ‘f’. In various embodiments, the collected configuration, utilization data, and the power model are used to generate server pool recommendations for power savings. In these and other embodiments, each of the servers in the server pool may be from different hardware families with correspondingly different power models.

In various embodiments of the power model, the monitored parameters of these servers, over a timestamp interval ‘T’, indicates whether the server pool is under-utilized and some power savings can be obtained. If so, then selected servers in the pool are recommended to be transitioned to a low power state. In these and other embodiments, the selection of which servers to transition to a low power state may be based on the utilization metrics of the servers, obtained from the monitored data, and the power efficiency of that server in comparison to others, obtained from the power model. Additionally, the servers selected to be transitioned to a low power state may be selectively transitioned to multiple low power modes if available and supported by the server's hardware. The decision on which low power mode is selected may be based on the server's utilization history and the overhead associated with going in, and coming out of, each low power state.

In various embodiments, the cost savings associated with a recommendation represents the dollar amount a recommendation could save if it was implemented starting from time (‘T’) up to the next (‘M’) months. As an example, cost savings may be calculated by taking the time interval frequency ‘T’ during which a target server was running at a specific recommendation time and multiplying it by 3 ‘M’ for the next 3 months. Based on the clock frequency and the change in utilization, the power savings is then calculated from the power model. In turn, the power savings is multiplied by the power rate plan, which results in the total amount of savings.

In various embodiments, the confidence level of a recommendation is a function of the quality of operational data, quantity (e.g., sample size) of operational data, and the nature of recurrence of the statistical and stochastic patterns in the operational data. Likewise, risk is calculated specific to each power-saving operation performed on a resource in the data center. For example, as illustrated in Case ‘2’ 612 Optimize Server Pool Stand-by Mode, the risk is tied to CPU utilization and the average CPU utilization needed when a system is recommended to be placed in standby or shut down.

More specifically, a recommendation is generated by a recommendation generation algorithm, where a corner point 618 is defined as a tuple of Capacity 602 and Power 604, and Unpacked Capacity 610=Sum(average of utilization between time T1 and T2 for all servers).

As an example of the use of the recommendation generation algorithm:

Current_Time = 0
DataRepository_Flush_Interval = 900 (seconds)
Consolidation_Interval = DataRepository_Flush_Interval * N (in

seconds) (N is be default set to 4)

For all Server S_i in the Pool

CPU[i] = CPU capacity of server S_i
Mem[i] = Memory capacity of server S_i

CPU_total = Compute the total server CPU capacity for the pool
Mem_total = Compute the total server Memory available in the Pool
While (true)

Current_Time += Consolidation_Interval
For all Server S_i

X[i] = CPU utilization from new samples in

DataRepository

M[i] = Memory Active from new samples in

DataRepostitory

X[i] = X[i] * CPU[i]
If(Current_Time > last sample in DataRepository)

Y[i] = Predict(Current_Time,

Consolidation_Interval, X[i])

Else

Y[i] = X[i]

Global CPU utilization CU = (Sum of all Y[i]/CPU_Total)
Global Memory Pool Utilization CM = (Sum of all

M[i]/Mem_total)

If (CU > CM) /*Pick the most constrained resource */

U = CU

Else

U = CM

If U > Consolidation_Upper_Threshold

Add one more server S_i to the pool
Add a recommendation in RECOMMENDATION_DB

to switch on S_i at Current_Time

Else if U > Consolidation_Lower_Threshold

Continue

Else

Capacity_Unpacked = sum of all Y[i]
While(Capacity_Unpacked > 0)

Collection C = Null
For each Server S_i,

pick a least slope corner point C_i such

that utilization at C_i <
Capacity_Unpacked

C.add(C_i)

Pick the corner point C* with the least slope in

C. (Break ties by X[i]. Servers that have
higher utilization get preference)

Pack the server corresponding to C*
Capacity_Unpacked −= Capacity of the server

corresponding to C*

Remove the server corresponding to C* from the

server list

End-while

End-if

For all servers S_i with no corner point selected at Current_Time

Add a recommendation in the RECOMMENDATION_DB to

switch off S_i to a low power mode at Current_Time

End-While
Method Predict(Current_Time, Consolidation_Interval, X[i])

Y[i] = Y_old[i] + (1 − ) X[i]

Y_old[i] = the prediction in the interval [Current_Time −

Consolidation_Interval, Current_Time]

X[i] is the most recent data.

In various embodiments, Method Predict is only used if a recommendation is to be made for an interval where data is not available (e.g., in the future).

Select a low power mode for the server based on the monitored utilization

Let average utilization of a server be=avgU.
Let there be two low power states: StateA and StateB.
Let the respective thresholds be StateA_Threshold and StateB_Threshold. StateA is more power saving than StateB and hence its StateAThreshold<StateBThreshold
If avgU, StateA_Threshold, then put the server in state A
Else put it in state B

In various embodiments, the recommendation generation algortithm may be run in background or invoked explicitly by a user.

As shown in FIG. 6 the algorithm is used for solving Case ‘2’ 612. In Case ‘2’ 612 a predetermined amount of capacity (‘C’) 602 is available to pack in a server pool. The goal of Case ‘2’ 612 is to select servers in the pool such that all available capacity ‘C’ 602 is packed while likewise minimizing the total power consumption 604 of the servers in the pool. In various embodiments, the algorithm sets UnpackedCapacity equal to the total amount of capacity ‘C’ 602 needed to provision predetermined servers in the server pool. In these and other embodiments, a server ‘i’ and its corresponding operating point (Power P_i ,Capacity CPU(i)) is selected, with the assumption that the selected server will run at the specified operating point. Accordingly, Unpacked Capacity 610 can be reduced by CPU(i) 608 after the server is selected. Additional servers are then iteratively selected in the server pool until UnpackedCapacity 610 is 0. Execution of this process requires addressing two questions:

(i) which server to select next for packing, and

(ii) what is the operating point for the server

In order to address the first question, the second question is addressed to determine the optimum operating point for each server in the server pool. Once determined the server with the best operating point is selected.

FIG. 6 graphically illustrates how the second question is addressed for a target server, which has a corresponding power Vs Capacity curve 620. As shown in FIG. 6, there can be two cases, Case ‘1’ 610 and Case ‘2’ 612. In Case ‘1’ 610, UnpackedCapacity is small. More specifically the UnpackedCapacity is smaller than the peak capacity CPU[i] 608 of the server. In Case ‘2’ 612, UnpackedCapacity is large. More specifically, UnpackedCapacity is larger than CPU[i] 608. Those of skill in the art will realize that only UnpackedCapacity can be packed on the target server in Case ‘1’ 610, and accordingly, this is the eligible region 606 for the server.

As a result, all corner points 614 through 622 between 0 and UnpackedCapacity are considered and the corner point with the optimum tan \theta is selected. The selected corner point is then returned as the best point for the server i. If Case ‘2’ 612 holds, then the eligible region is the complete range of the server (full plot). All corner points 614 through 622 in the eligible region 606 are checked once again and the corner point with the least slope (i.e., tan \theta) is returned. As shown in FIG. 6, corner point 622 has the smallest slope in the eligible region 606 for Case ‘1’. As likewise shown in FIG. 6, the best slope 616 for the complete range of the server is selected if Case ‘2’ 612 holds. Once the best corner points for each individual server is determined, the best corner point across all servers in the pool is selected. More specifically, the server in the pool whose selected corner point has the least slope is selected.

Although the present invention has been described in detail, it should be understood that various changes, substitutions and alterations can be made hereto without departing from the spirit and scope of the invention as defined by the appended claims.

What is claimed is:

1. A computer-implemented method for managing power consumption in a plurality of information processing systems, comprising:
receiving utilization data and power consumption data corresponding to individual information processing systems in the plurality of information processing systems, wherein the utilization data and power consumption data corresponds to a plurality of CPU frequencies;
processing the utilization data and power consumption data to generate power consumption model data for the individual information processing systems, wherein the utilization data and power consumption data comprises historical utilization data corresponding to the plurality of CPU frequencies and the power consumption model data comprises an efficiency value;
processing the power consumption model data to select an information processing system comprising a target efficiency value; and
changing the power consumption level of the selected information processing system to reduce its CPU frequency.

2. The method of claim 1, wherein the processing of the power consumption model data generates a power consumption model comprising:
a piecewise linear regression model;
an extrapolation of a base power rating and a maximum power rating; and
a plurality of power consumption model extrapolations for a plurality of CPU frequencies.

3. The method of claim 1, wherein historical utilization data corresponding to a plurality of power consumption levels associated with the selected information handling system is processed to determine the changed power consumption level of the selected information processing system.

4. The method of claim 3, wherein the power consumption model data and the historical utilization data is processed to generate cost savings data.

5. The method of claim 4, wherein the cost savings data and historical CPU frequency data corresponding to the plurality of power consumption levels associated with the selected information handling system is processed to generate risk data.

6. The method of claim 5, wherein the cost data and the risk data is processed to generate a power consumption management recommendation.

7. A system comprising:
a processor;
a data bus coupled to the processor; and
a computer-usable medium embodying computer program code, the computer-usable medium being coupled to the data bus, the computer program code used for managing power consumption in a plurality of information processing systems and comprising instructions executable by the processor and configured for:
receiving utilization data and power consumption data corresponding to individual information processing systems in the plurality of information processing systems, wherein the utilization data and power consumption data corresponds to a plurality of CPU frequencies;
processing the utilization data and power consumption data to generate power consumption model data for the individual information processing systems, wherein the utilization data and power consumption data comprises historical utilization data corresponding to the plurality of CPU frequencies and the power consumption model data comprises an efficiency value;
processing the power consumption model data to select an information processing system comprising a target efficiency value; and
changing the power consumption level of the selected information processing system to reduce its CPU frequency.

8. The system of claim 7, wherein the processing of the power consumption model data generates a power consumption model comprising:
a piecewise linear regression model;
an extrapolation of a base power rating and a maximum power rating; and
a plurality of power consumption model extrapolations for a plurality of CPU frequencies.

9. The system of claim 7, wherein historical utilization data corresponding to a plurality of power consumption levels associated with the selected information handling system is processed to determine the changed power consumption level of the selected information processing system.

10. The system of claim 9, wherein the power consumption model data and the historical utilization data is processed to generate cost savings data.

11. The system of claim 10, wherein the cost savings data and historical CPU frequency data corresponding to the plurality of power consumption levels associated with the selected information handling system is processed to generate risk data.

12. The system of claim 11, wherein the cost data and the risk data is processed to generate a power consumption management recommendation.

13. A computer-usable medium embodying computer program code, the computer program code comprising computer executable instructions configured for:
receiving utilization data and power consumption data corresponding to individual information processing systems in the plurality of information processing systems, wherein the utilization data and power consumption data corresponds to a plurality of CPU frequencies;
processing the utilization data and power consumption data to generate power consumption model data for the individual information processing systems, wherein the utilization data and power consumption data comprises historical utilization data corresponding to the plurality of CPU frequencies and the power consumption model data comprises an efficiency value;
processing the power consumption model data to select an information processing system comprising a target efficiency value; and
changing the power consumption level of the selected information processing system to reduce its CPU frequency.

14. The computer usable medium of claim 13, wherein the processing of the power consumption model data generates a power consumption model comprising:
a piecewise linear regression model;
an extrapolation of a base power rating and a maximum power rating; and
a plurality of power consumption model extrapolations for a plurality of CPU frequencies.

15. The computer usable medium of claim 13, wherein historical utilization data corresponding to a plurality of power consumption levels associated with the selected information handling system is processed to determine the changed power consumption level of the selected information processing system.

16. The computer usable medium of claim 15, wherein the power consumption model data and the historical utilization data is processed to generate cost savings data.

17. The computer usable medium of claim 16, wherein the cost savings data and historical CPU frequency data corresponding to the plurality of power consumption levels associated with the selected information handling system is processed to generate risk data.

18. The computer usable medium of claim 17, wherein the cost data and the risk data is processed to generate a power consumption management recommendation.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
